(19) United States
(12) Patent Application Publication
(10) Pub. No.: US 2003/0120795 A1
(43) Pub. Date: Jun. 26, 2003

(54) Method for capacity enhancement of packet switched networks

(75) Inventor: Menahem Reinshmidt, (US)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Marnetics Ltd.

(21) Appl. No.: 10/022,912

(22) Filed: Dec. 20, 2001

(51) Int. Cl. G06F 15/16; G06F 15/173

(52) U.S. Cl. 709/232; 709/223

(57) ABSTRACT

According to the present invention there is provided a method for increasing data capacity in packet switched networks, by providing an improved queuing mechanism, incorporating both packet classification and FIFO methodologies into the queue management policy. This method thereby enables management of queues so as to best impact on perceived performance from the users perspective. A queue management system is provided for that comprises setting up of an advanced classifying module that considers the packet headers as well as considers the arrival time of packets and events or changes in the session, for their impact on the perceived performance of packets. The present invention also comprises the creation of a single physical queue that enables packets to be dynamically positioned and managed during open sessions. This queue therefore integrates the packet priority criterion, and other criteria such that packets in the queue are intelligently positioned.

### FIELD AND BACKGROUND OF THE INVENTION

1. Field of the Invention

The present invention relates to a method for enhancing physical bandwidth capacity in packet-switched networks. In particular, the present invention relates to a means for enabling an improved queue management policy for data networks.

2. Description of the Related Art

The concept of network capacity is a vital yet undefined field, as it depends on the needs, aims and usages of a network. Generally, capacity refers to the serving of data, by a network resource, to a plurality of users, at a pre-defined performance level. In circuit switched networks, this capacity is fixed, determined according to the configuration of the network, and is stable and un-dynamic. In packet switched networks, the capacity is defined according to data grams that can be transferred through a fixed physical data channel or line. The capacity of such a network is dynamic and constantly changing. The capacity of a network is typically measured at the point where a network is challenged by an overflow of data, and therefore can be ascertained only at times of peak performance. According to this definition, capacity is defined at the moment when the entire quantity of data being served in a network is processed (this refers to the point in time where exactly 100% of the network capacity is being utilized), which is the point of congestion, or over subscription.

The reason for over subscription in such a network is that when too many packets are transferred in a network, a queue of packets is formed, and the packets have to wait their turn in the queue before being processed or serviced. When there is no queue, the network is being not-fully utilized. When there is a queue, the network is oversubscribed. The impact of over subscription, however, is something that is determined by the network management policy, which manages queues according to determined policies.

The management of queues impacts significantly on the service given to packets. As can be seen in FIG. 1, a typical queue management policy is the service that governs the queue. Various methods have been utilized and proposed for managing queues. The classic method, that fits into the service shown in FIG. 1, is the of First In First Out (FIFO) method. According to this method, each subsequent packet that arrives at a network bottleneck simply joins in the queue, similarly to a traffic jam, and is subsequently extracted from the queue for usage, according to the order of arrival. This method therefore takes ample care of chronology of packet arrival, such that session integrity is maintained. However this method does not enable the streamlining of higher priority data over lower priority data, which can negatively affect network performance. More recent queue management policies have been developed, the most prominent currently in use being Class Based Queuing (hereinafter referred to as “CBQ”) This method, as well as many other queuing management policies, fits into a general method whereby a plurality of logical queues are utilized to process data packets, according to their classification. Such classification typically considers the TCP headers of such packets in deciding what priority to give particular packets. An enhancement on CBQ is Fair Weighted Queuing, sometimes referred to as Weighted Fair Queuing (and hereinafter referred to as “FWQ”). FWQ incorporates both packet classification in multiple logical queues (from CBQ) as well as smoothing (fairness), in order to ensure that no session consumes a disproportionate proportion of network capacity at a particular time. Accordingly, the number and type of queues is determined by the queue management policy, and queues may be created to represent packet various priority levels. For example, as can be seen in FIG. 2, a queue management policy may determine that packets need to be divided into high, medium and low priority queues, according to pre-determined criteria. For example, voice packets get the highest priority, Web pages get medium priority, and email messages get low priority. Accordingly, as can be seen in FIG. 2, a categorizing engine/component 21 will read the TCP headers of all incoming packets 20 to determine the priority of a packet. Once the packet enters into its queue, whether queue 22, queue 23 or queue 24, it stays there and waits its turn to be processed, by the data output mechanism 25, according to the FIFO mechanism. The determination of how to process the various queues, i.e. the order of data output, is determined by the queue management policy. For example, the queue management policy may require that the data output mechanism 25 reads X high priority packets, which is followed by reading turn X/2 medium priority and X/4 low priority packets in one processing round, and to constantly repeat this process (like a round robin). A packet entering a network resource, such as a server or router is therefore classified, transferred to a logical queue, and finally serviced when its turn arrives. The queues themselves are simple pipes that hold lists of messages. A new message arriving is positioned by default at the end of the queue.

The disadvantages of such queue management policies are:

1—Criterion of classification of packets is fixed, and therefore once a packet enters its classified queue it stays there, without considering its inner content and importance. Furthermore, all packets that make up a session are treated equally, in spite of changing session conditions. Therefore, new sessions are treated as all other sessions. This is because the packets, once transferred to their queues, wait in the queues behind other packets, irrespective of the type of packet it is. Therefore event though a user may appreciate initial data packets from a session more than latter packets, this aspect of user appreciation is not considered. Furthermore, re-transmitted packets are similarly treated as other packets, without consideration of their special nature.

2—Packet time of arrival is not fully considered. For example, it may occur that two packets, one high priority packet arriving first, and one low priority packet arriving subsequently, may be distributed to their respective queues. However, it may be that there is a long line of packets in the high priority queue, and no line in the low priority queue. Therefore, in this case, it may well happen that the low priority packet will be processed before the high priority packet, as time of arrival is not considered by the data outputting mechanism 25 (round robin component).

These disadvantages cause a substantial difference to the data throughput, as perceived by users.

There is thus a widely recognized need for, and it would be highly advantageous to have, a method that can enable capacity enhancement of existing physical bandwidth in packet switched networks, and such that enables a queue management policy that is intelligent and dynamic, and considers the type and timing of packets, as well as special events in the session lifetime, when providing service for such data.

### SUMMARY OF THE INVENTION

According to the present invention there is provided a method for enhancing data capacity of existing physical bandwidth in packet switched networks, by providing an improved queuing mechanism. According to the present invention, both packet classification and FIFO methodologies are incorporated into queue management policies, thereby enabling management of queues so as to best impact on perceived performance from the users perspective. The present invention provides a queue management system that comprises setting up of an advanced classifying module that considers the packet headers as well as considers the arrival time of packets and events or changes in the session, for their impact on the perceived performance of packets. The present invention also comprises the creation of a single physical queue that enables packets to be dynamically positioned in any place in the queue during open sessions. This queue therefore integrates the packet priority criterion, as well us other criteria such as smoothing and packet states, so that packets in the queue are intelligently positioned.

### BRIEF DESCRIPTION OF THE DRAWINGS

The invention is herein described, by way of example only, with reference to the accompanying drawings, wherein:

FIG. 1 is an illustration of traditional queue management, illustrating the FIFO-type queue.

FIG. 2 is an illustration of current methods of queuing, using multiple queues.

FIG. 3 is an illustration of the queue management policy according to the present invention, wherein a single managed queue is utilized.

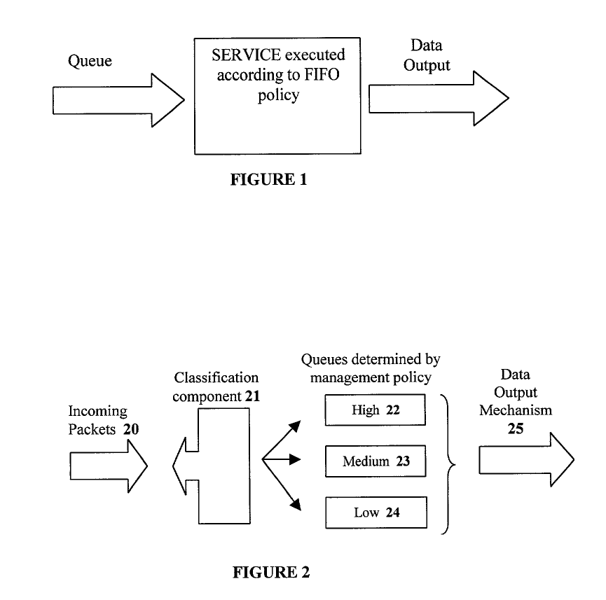

### DESCRIPTION OF THE PREFERRED EMBODIMENT

The present invention relates to a method for enhancing data capacity of existing physical bandwidth in packet switched networks, by providing an improved queuing mechanism and queue management system.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention can be used to manage queuing such that both packet classification and FIFO methodologies are incorporated into queue management policies. This method thereby enables managing queues so as to best impact on perceived performance from the users perspective.

According to the present invention, the actual performance of data packets are not considered as important as the perceived performance from the users perspective. An example of this is the case where two end users are accessing a Web site. The first user requests a page, which subsequently takes 15 seconds to load, and loads completely at that time. A second user requests the same page, which starts to download immediately, yet takes 20 seconds to be completed. It is clear that event though the first user experienced a quicker total download of the page (reflecting objectively better performance), the second user got a much better user experience, as he/she received an immediate response. In this case, immediate response is vital, and so the perceived performance (subjective) is more important than the actual performance. The time element is vital to the user experience, and according to the present invention, must be factored into the queue management policy.

According to the present invention, therefore, capacity is defined as the serving of data, by a network resource, to a plurality of users, at a pre-defined PERCEIVED performance level. For example, it may be determined that the initial bytes/packets in any session, or the re-transmitted packets of a session, must be given highest priority at all times. As such, both the arrival time of new packets and the packet types are considered, when classifying arriving packets in a queue. For example, in the case of the users accessing a Web site, it may be determined that the immediate downloading of the initial data is vital, and so this capacity would be incorporated into the queue management policy.

This capacity enhancement requires, in addition to its TCP header data (which is used for conventional classification), the usage of a packet's upper layer protocol (ULP) header/s in order to make a more thorough analysis of data packets on a per packet basis, including factors such as the data content, type state and history. ULP refers to various protocols, including FTP, HTTP, SMTP, RTP etc.

The principles and operation of the system and a method according to the present invention may be better understood with reference to the drawing and the accompanying description, it being understood that this drawing is given for illustrative purposes only and is not meant to be limiting, wherein:

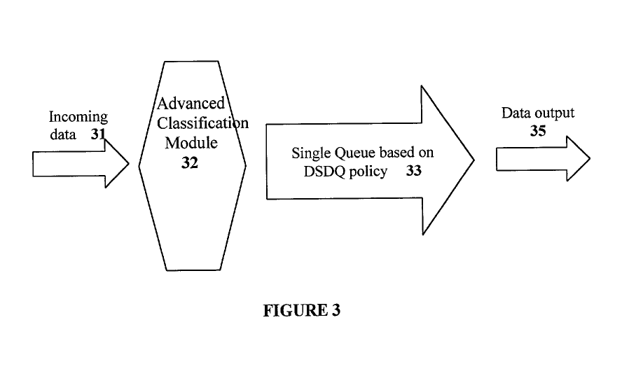

As can be seen in FIG. 3, the present invention replaces the conventional queue system, wherein there is a priority classifier, a multiple queue structure and an outputting mechanism (round robin), with a single physical queue 33 that is managed by a Discreet State Driven Queuing (DSDQ) policy, such that session types and dynamics, in addition to packet classification, are considered in positioning packets in the single queue. The present invention thereby replaces the conventional queue system with a queue management system that comprises:

i. an advanced classifying module 32—this module considers the packet header as well as data content of each individual incoming packet 31, for intelligently classifying each packet’s priority (as in done in known systems), smoothing and a packet's state. These criteria include consideration of the arrival time of packets, events or changes in the session that impact on the user experience (perceived performance of packets), and the actual status of the queue. This module achieves the advanced classification by analyzing the packet headers, IP addresses of packets, and history of a queue in order to define these factors.

ii. a single physical queue 33 that enables packets to be dynamically positioned and managed during open sessions. This queue integrates the packet priority criterion, and other criterion, such that packets in the queue are intelligently positioned. The Advanced Classifying Module 32 uses the architecture of the Single Queue 33 to position packets in the queue according to chosen criterion, packet types, time of arrival of packets, and any other chosen criteria.

iii. A output mechanism 35 that extracts packets from the queue. For example, the output mechanism may takes packets from the front of the queue, such that no round robin mechanism is required, in order to take and distribute packets.

The positioning of packets in the queue may be executed such that chosen packets can be dynamically placed at any position in the queue, and can thereby be advanced or relegated in the queue according to the need. In addition, spaces can be purposefully left in chosen places in the queue, or at the end of the queue, for expected or potential packets, so that the whole queue will not be required to be adapted with the arrival of a packet in the queue.

This combination of components enables improved perceived performance, or increased throughput from the user perspective. This in turn enhances the network capacity.

According to the present invention, the classification of packets into a hierarchy of queues has been replaced by an intelligent queue management system that classifies packets into a single queue, and that enables the positioning of packets anywhere in such a queue, ranked according to multiple criterion and factors.

The considerations for positioning packets in this queue, which are included in the classifying procedure, include the following: Priority, Smoothing, States and Types.

1. Priority:

This criterion considers the upper layer protocol (ULP) headers, and classifies packets according to IP addresses, data type etc., on a per packet basis. The classifying of packets according to priorities is achieved in systems known in the art (such as WFQ and CBQ). As such, the basic priority sorting incorporates the provision of differentiated services, according to factors such as addresses, data type etc.

In addition, the priority of a packet may also be changed dynamically during a session lifetime, such that the various packets belonging to a certain session may be given different priorities. Such factors enable changing the session priority on the go, during a session, according to the changing events surrounding a session.

2. Smoothing:

It is possible that a session, due to its data heavy makeup, may come to dominate a queue in a disproportionate way, thereby using up a disproportionate amount of system resources. An advanced smoothing process, according to the present invention, is employed, in order to discriminate against such a session by scaling down its relative presence in a queue, so that it regains a proportional presence, or a fair representation in the queue.

Furthermore, the advanced smoothing process according to the present invention, considers packet priority. For example, a high priority packet will possibly be given a better position in the queue than a lower priority packet.

Moreover, the smoothing consideration, according to the present invention, also considers the history of sessions to determine fair packet representation. A virtual history queue, for example, may be maintained to monitor previously sent packets, in order to bring into consideration session performance in deciding how to represent packets proportionally.

3. States:

States refer to a family of states, patterns or session types, which impact significantly on perceived performance of a network. The states are identified by analyzing TCP headers as well as ULP headers of packets, in order to identify and analyze content-related data for each packet. Session progress is also analyzed, based on various other criteria, thereby enabling improved classification of data packets into states.

These states currently include:

i. New session packets: Packets with data that comes from sessions with no packets currently in the queue are given a much higher priority than packets from a session in progress. For example, the perceived performance by the user can be said to favor the initial packets containing the initial response to a request, more than the following packets.

ii. Retransmitted packets: Packets that are identified as having been previously sent and are being retransmitted, may hold up entire sessions in certain protocols (such as TCP). As such, until these packets arrive at the client, the entire request will often be suspended, causing very poor perceived performance. These packets are therefore given a high priority in the queue.

iii. Session Syn Packets: These packets, such as Syn (synchronization) Packets in a TCP environment, are used to initialize sessions, and are also considered more important for the user experience than ordinary session packets, and so are given a higher priority.

iv. Burst Packets: There are situations wherein a session sends a series of packets simultaneously, which subsequently dominate a queue due to their disproportionate representation. The present invention breaks up these consecutively positioned packets, optionally interleaving, in order to put gaps between these packets, according to chosen criteria. Gaps may be placed between packets in a queue in any chosen situation, whether to prevent domination of a queue by burst packets or for any other reason.

v. Signaling and control packets: Certain packets are used to influence session progress by identifying relevant factors. For Example Syn packets (for initializing sessions) and FIN packets.

vi. Special Events in the Upper Level Protocol (ULP) levels such as TCP, HTTP, UDP etc.: There may be situations or events in ULP headers that impact on the perceived performance of a network, such as recognizing GET commands in a HTTP session, which are part of the data sent in a packet. These packets are therefore given a higher priority.

vii. Events connected to real time and/or synchronized and/or delay sensitive applications:

Certain applications, such as voice over IP and video over IP, require jitter compensation to stabilize and regulate data reception by users. As such, packets with this type of data are required to be accelerated or decelerated in order to improve the perceived performance, and are therefore given a higher or lower priority.

Alternative states may be defined and integrated into the improved classification procedure according to the present invention. Each state is discreet, in the sense of being non-related or independent on other states, yet is considered by the queue management policy while determining packet positioning. Therefore, instead of processing packets from classified queues wherein states are not considered, the queue management method, according to the present invention, utilizes these discreet states to improve perceived performance. The method of present invention is hereinafter referred to as “Discreet State Driven Queuing”, or “DSDQ”.

4. Type:

This criterion considers the session type, such as real-time or non-real-time sessions, and classifies packets according to such session types. In addition, the packet type may also be changed dynamically during a session lifetime, such that the various packets types belonging to a certain session may be given different priorities. Such factors enable changing the packet type on the go, during a session, according to the changing events surrounding a session.

Therefore the present invention consolidates the logical queues of queuing methods known in the art into a single physical queue that is managed by the DSDQ policy. This DSDQ method intelligently classifies packages before entering them into the queue, and can position the packages in the queue according to their importance, priority and other factors. In this way, priority, smoothing considerations, packet/session states, and possible alternative criterion are used when classifying packets for the queue. The present invention thereby combines the advantages of the conventional packet classification procedure, the First In First Out (FIFO) type of operation, and other dynamic factors in improving perceived performance in a network.

The present invention enables the described DSDQ policy according to the following guideline:

i. classifying data packets according to criteria including packet priority, smoothing, packet states and packet types;

ii. placing classified packets in a single physical queue;

iii. positioning the packets in any place in the queue; and

iv. extracting the packets from the queue, and processing or distributing the packets.

The present invention furthermore provides a method for performance enhancement in packet switched networks, by enabling an improved drop-policy for data packets in an overloaded queue. Such a policy is based on similar criteria as those discussed above, such that implementation requires:

i. classifying each individual data packet in a queue, such that the packet classifying incorporates factors including priority, smoothing and states; and

ii. discarding chosen individual packets based on said classification.

Alternative Embodiments

Several other embodiments are contemplated by the inventors, including:

1. Switching of queue management policy:

The present invention enables a queue management policy that may be changed during sessions in order to make the most efficient usage of system resources. For example, if at the beginning of a session the network in being under-utilized, the queue management policy may determine to use the simple FIFO queue management policy. However, at a certain problem level of network traffic, determined according to queue length and queue growth rate, the queue manager can switch the queue management policy to that of CBQ, FWQ, or DSDQ etc. This embodiment thereby enables saving of system resources at low traffic periods.

2. Multi-directional DSDQ:

The preferred embodiment of the present invention provided for a unidirectional DSDQ mechanism, which provides capacity enhancement for a single channel. If, however, a queue manager would want to provide a two-directional mechanism, this may be achieved by implementing the above-mentioned methodology and system in a multi-directional configuration.

3. Multiple DSDQs:

In the case where a network entity provides a plurality of data channels, there may be a need to install the DSDQ mechanism on each channel. However, in an additional preferred embodiment of the present invention it is possible to implement a box with the DSDQ mechanism in the central router. This single box will enable the transfer of data to multiple channels, such that a single DSDQ mechanism functions on all of the channels.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A system for enhancing capacity in a packet switched network, wherein data queues are intelligently managed, comprising:
i. an advanced classifying module;
ii. a single physical queue; and
iii. a data output mechanism for extracting said data from said queue.

2. The system of claim 1, wherein said advanced classifying module enables advanced classification of data packets based on criteria selected from the group consisting of packet priority, smoothing, packet states, arrival time of new packets, packet types and packet data content.

3. The system of claim 1, wherein said advanced classifying module manipulates classified packets by positioning said classified packets in chosen places in said single physical queue.

4. The system of claim 1, wherein said single physical queue enables packets to be positioned in any place in said queue during open sessions.

5. A method for enhancing capacity in a packet switched network, comprising the following steps:
i. classifying data packets according to criterion selected from the group consisting of packet priority, smoothing, packet states and packet types;
ii. placing said classified packets in a queue; and
iii. extracting said packets from said queue.

6. The method of claim 5, wherein said placing said packets further includes positioning said packets in any place in said queue.

7. The method of claim 6, wherein said queue is a single physical queue.

8. A method for capacity enhancement by improved queue management in a packet switched network, comprising the following steps:
i. classifying each individual data packet; and
ii. positioning each said individual data packet anywhere in a queue, according to a predefined state.

9. The method of claim 8, wherein said positioning further comprises leaving open spaces in said queue for potential packets.

10. The method of claim 8, wherein said queue is a single physical queue.

11. The method of claim 8, wherein said classifying data packets incorporates factors selected from the group consisting of packet priority, smoothing, packet states and packet types.

12. The method of claim 11, wherein said priority incorporates dynamic session factors.

13. The method of claim 11, wherein said smoothing further comprises factors selected from the group consisting of session history and queue history.

14. The method of claim 11, wherein said classifying data packets into states is based on the round trip time criteria for data sessions.

15. The method of claim 8, wherein said states incorporate packets selected from the group consisting of new session packets, retransmitted packets, session initialization packets, burst packets, signaling and control packets, special events in the application protocol level based packets, and events connected to real time synchronized applications based packets.

16. A method for performance enhancement in a packet switched network, by enabling an improved drop-policy for data packets in an overloaded queue, comprising the following steps:
i. classifying each individual data packet, such that said classifying incorporates factors selected from the group consisting of priority, smoothing and states; and
ii. discarding chosen individual packets based on said classification.

17. A method for enabling data network capacity enhancement by improved management of packets in a queue, comprising the steps of:
i. classifying the packets according to priority, by determining the individual characteristics of any individual packets;
ii. considering a smoothing procedure so as to represent said packets fairly;
iii. considering states of each said packet, so as to represent special events;
iv. positioning said packets anywhere in a single physical queue.

18. The method of claim 17, wherein said considering states of each packet further comprises defining packet types selected from the group consisting of first data packets in a newly established session, retransmitted packets, session initialization packets, burst packets, signaling and control packets, special events in the upper layer protocol level packets, events connected to real time applications packets, events connected to synchronous applications packets, and events connected to delay sensitive protocols packets.

19. A method for intelligent classification of data packets in packet switched networks, such that packets are intelligently classified, according to the following steps:
i. analyzing the packets' ULP headers, said analyzing enabling defining of packet priority on a per packet basis;
ii. analyzing queue history for a data communication session that includes the packets, such that session dynamics can be identified; and
iii. analyzing session history for said data communication session, such that said session dynamics can be identified.
iv. analyzing content-related data of the packets, such that packet states can be identified.

20. A method for switching queue management policies during open data transfer sessions in a packet switched network, comprising the steps of:
i. operating a queue management policy for the network, according to a simple queue management policy mechanism, while there is low utility of data queues;
ii. monitoring said queues to determine queue length;
iii. monitoring said queues to determine queue growth rate;
iv. deciding at a chosen network traffic level to implement an alternative queue management policy, based on said queue length and said queue growth criteria.

21. A method for switching queue management policies for open data transfer sessions in a packet switched network, comprising the steps of:
i. operating a queue management policy for the network, according to a chosen queue management policy mechanism, while there is high utility of data queues;
ii. monitoring said queues to determine queue length;
iii. monitoring said queues to determine queue growth rate;
iv. deciding at a chosen network traffic level to implement a more simple queue management policy, based on said queue length and said queue growth criteria.

22. A method for providing a multi-directional capacity enhancement mechanism for physical bandwidth in a packet switched network, comprising:
i. providing a DSDQ mechanism in an outgoing data channel for enhancing said data channel capacity; and
ii. providing a DSDQ mechanism in an incoming data channel for enhancing said data channel capacity.

23. A method for providing a point to multi-point configuration for enhancing network bandwidth capacity for a plurality of data channels in a packet switched network, comprising:
i. providing a box with a DSDQ mechanism, for enhancing the data channels capacity; and
ii. configuring said box with DSDQ mechanism in a centralized node for enabling enhanced queue management for each queue for each of the data channels.
